(19) United States
(12) Patent Application Publication
(10) Pub. No.: US 2020/0285784 A1
(43) Pub. Date: Sep. 10, 2020

(54) SYSTEMS AND METHODS FOR GENERATING A SIMULATED ENVIRONMENT

(71) Applicant: Simulation Engineering, LLC, Estero, FL (US)

(72) Inventors: Steven ISBEL, Estero, FL (US); Rick JOHNSON, Estero, FL (US)

(21) Appl. No.: 16/712,331

(22) Filed: Dec. 12, 2019

Related U.S. Application Data
(60) Provisional application No. 62/811,276, filed on Feb. 27, 2019.
(60) Provisional application No. 62/854,402, filed on May 30, 2019.

(51) Int. Cl. G06F 30/13

(52) U.S. Cl. CPC G06F 30/13; G06F 2111/16

(57) ABSTRACT

The technology described herein relates to a system for generating a simulated environment for, among other aspects, modeling property. In more detail, the technology relates to generating a virtual three dimensional (“virtual 3-D”) space having one or more virtual characters associated with one or more users. The virtual 3-D environment, in one non-limiting example, can simulate a process for selecting and viewing property by allowing a user to simulate engagement with a realtor and/or view and engage with the property using virtual reality technology. For example, a user may wear a virtual reality headset that enables him/her to simulate visiting a realtor's office where the user can then select one or more properties to view. Upon selection, the user may enter view the property in the virtual environment and engage with different elements associated with the property.

### CROSS REFERENCE TO RELATED APPLICATION(S)

This application claims priority to U.S. Patent Application No. 62/811,276 filed on Feb. 27, 2019 and U.S. Patent Application No. 62/854,402 filed on May 30, 2019, the entire contents of each of which are hereby incorporated by reference for all purposes.

### TECHNICAL OVERVIEW

The technology described herein relates to a simulated environment. More specifically, the technology described herein relates to a system that generates a simulated environment for, among other aspects, modeling property.

### INTRODUCTION

Technology is available for generating a simulated environment for modeling property, such as, a commercial building or residential house. For example, technology is available for generating a virtual three-dimensional space representing property where a user can simulate the experience of viewing the property using virtual reality technology.

While many advances in this domain have been achieved over the years, it will be appreciated that new and improved techniques, systems, and processes in this domain are continually sought after.

### COPYRIGHT NOTICE

A portion of the disclosure of this patent document may contain material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### SUMMARY

The technology described herein relates to a system for generating a simulated environment for, among other aspects, modeling property. In more detail, the technology relates to generating a virtual three dimensional (“virtual 3-D”) space having one or more virtual characters associated with one or more users. The virtual 3-D environment, in one non-limiting example, can simulate a process for selecting and viewing property by allowing a user to simulate engagement with a realtor and/or view and engage with the property using virtual reality technology. For example, a user may wear a virtual reality headset that enables him/her to simulate visiting a realtor's office where the user can then select one or more properties to view. Upon selection, the user may interact with the property in the virtual environment and engage with different elements associated with the property.

This Summary is provided to introduce a selection of concepts in a simplified form that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

FIG. 1 shows a non-limiting example diagram of a user wearing a virtual reality headset;

FIG. 2 depicts a non-limiting example block diagram of different software components comprising the system;

FIGS. 3A & 3B show non-limiting example flowcharts showing a flow of processes for the technology described herein;

FIG. 4 shows a non-limiting example diagram of an application design and workflow;

FIGS. 5A-E show non-limiting example user interfaces generated for display;

FIGS. 6A-F show further non-limiting example user interfaces generated for display; and

FIG. 7 shows a non-limiting example block diagram of hardware components comprising the system shown, at least, in FIG. 2.

### DETAILED DESCRIPTION

In the following description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely in order to orient the reader as to the general subject matter of each section; as will be seen below, the description of many features spans multiple sections, and headings should not be read as affecting the meaning of the description included in any section.

### OVERVIEW

The technology described herein relates to, among other topics, a system for generating a simulated environment that enables users to be immersed in a virtual environment for selecting and viewing property, among other aspects. Conventional technology exists where users can view images of property using software applications, such as, Redfin® or Zillow®. In some instances, the applications may provide 3-D virtual tours that allow the user to virtually view various portions of the home. For example, the application may display a “3D View” indication for user selection upon which the user can obtain a guided 3-D tour of the home with circles on parts of the home (e.g., wall, floor) guiding the user through each room.

Such techniques are useful for providing the user a more comprehensive look and feel of the home. However, the conventional approach has drawbacks in that it cannot provide the user with a true immersive property viewing experience. More specifically, the conventional approach allows the user to “tour” the home by following a guided path that displays consecutive two-dimensional images showing various portions of the home along the path.

This technique, however, has limitations as to the user's ability to view and interact with the property. That is, the conventional technique lacks a method for allowing the user to be immersed into a virtual environment enabling the user to freely navigate and engage the property in a three dimensional space without limitation. For example, the conventional technique only allows the user to view two dimensional images and does not provide any ability for the user to interact with a virtual environment. Furthermore, the conventional technique provides no method for allowing the user to experience visiting property under different lighting and/or weather conditions.

The technology described herein is directed to providing a simulated virtual 3-D environment for allowing a user to be immersed into the property viewing experience. In one example, the technology is directed to generating a virtual 3-D space where a user can select property to view and then enter a virtual environment depicting the property. For example, the user may use a virtual reality headset to simulate being in the virtual 3-D environment and then manipulate a virtual character (e.g., using input devices) to move around the virtual space depicting the property. In the environment, the user may be able to interact with objects (e.g., turn on lights, open doors) and freely move around as if they were physically at the property. The technology thus advantageously provides the user with a real immersive experience allowing the user to virtually tour a property without ever having to physically visit the property.

In further detail, the technology described in this application further transcends the current workflow processes and provides the ability for real time manipulation and adjustments to current or future development of architecture. Some of the technologies involved in this application include Blender® (e.g., 3D Modeling Software), Unity® (e.g., Real-time Graphical Engine), Android® SDK/NDK, Photon® (e.g., Networking framework), and Oculus® (e.g., Utilities/Platform/Avatar). These technologies can be combined into the Unity application which is uploaded to Oculus servers for the use of Virtual Reality (VR) devices. It should be appreciated that the technologies described herein are of course non-limiting and the technology described in this application envisions using any type of software for development and implementation.

It should be appreciated that the system may receive an input file (e.g., CAD file) or floor plan, or could obtain measurements from an on-site measurement process. A new file may be created in 3-D modeling software and the software may generate a floor plan (e.g., exterior and interior including walls and floors). The building may add other objects including, but not limited to, windows and doors and the ceiling and roof may be generated as well. Other aspects of interior components may be generated (e.g., cabinets, baseboards, etc.) and material spots may be assigned. A real-time 3-D development platform may be opened and a new scene can be created in the application for a building/property. Certain additional items such as materials, lighting, and/or reflections may be added. Then, a binary file may be built and the binary file can be pushed to a VR headset, as a non-limiting example.

The technology described herein allows the user to view a 3D representation of 2D projects in various stages of development. This will allow the user to avoid costly mistakes in the development process and to showcase their projects to potential buyers, as one example. In addition, the technology will greatly speed up all phases of the development process and require less human workforce to conduct operations.

Conventional property construction is limited to viewing in 2D (e.g., using CAD); to understand the process of building and the architecture. This current limitation leads to overruns on time and allows for errors in the translation of 2D to reality. Consequently, parties bid on these 2D plans and make many errors in their bids. Moreover, these errors costs time and generally lead to altercations between, for example, a developer and a builder. This technology described herein solves such issues by providing a realistic view of the project in a virtual setting, for easier translation of what is being built. In addition, changes could be made in real-time between, for example, a general contractor and an architect. The problem with construction under the current process is it leaves a lot of room for interpretation to the person reading the building plans. The technology described herein provides a concrete solution thus eliminating interpretation errors. Furthermore, the technology described herein expedites the process because the user can truly see how the architect intended the building to be perceived in reality.

The conventional techniques currently in use are archaic to the modern processes of nearly every industry. The technology described herein will advance the real estate industry beyond other industries that use technology to enhance their needs. Of course, the technology is not limited to the real estate industry and can be applied (and will also advance) a variety of other industries including, but not limited to, construction industries and development industries.

In particular, the technology provides limitless possibilities for users to tour property and interact with the environment. The technology enables the user to immerse himself/herself in these environments with an easy-to-use interface that makes an archaic and limited process significantly simpler and limitless. The purpose of this technology is to render existing homes, buildings, land, and/or Planned Unit Development (PUD) in a virtual environment for users to view. The virtual environment can be altered and manipulated to offer the user a realistic understanding in multiple settings (e.g., Sunrise, Sunset, Daytime, Nighttime, Clouds, Rain, and Storms). Furthermore, the user no longer needs the company of a realtor to view prospective properties. By rendering property in VR, the technology allows users to view these properties from anywhere at any time. In addition, the technology allows the users to make changes to the property like color, trim, cabinets, doors, windows, flooring, fixtures, and renovation ideas, among other aspects. The end result is a more informed and more satisfied user in the process of buying and selling properties.

As another non-limiting example embodiment, the technology also envisions dynamic ability to switch structural viewpoints. For example, a user may navigate the virtual environment in a “normal view” where the user can interact with the property as if they were inside the fully built structure. The technology thus enables the user to switch viewpoints so that they can see one or more alternate views. For example, the user may switch to a plumbing viewpoint showing the internal plumbing configuration of the structure. The user may also switch to an electrical viewpoint to view the internal electrical configuration of the structure.

In conclusion, this technology is a viable solution for many aspects in the development, construction, and real estate industries. Users will be able to do all the processes that require a professional to navigate the landscape, which will greatly streamline all processes in these industries.

In many places in this document, software modules and actions performed by software modules are described. This is done for ease of description; it should be understood that, whenever it is described in this document that a software module performs any action, the action is in actuality performed by underlying hardware components (such as a processor and a memory) according to the instructions and data that comprise the software module.

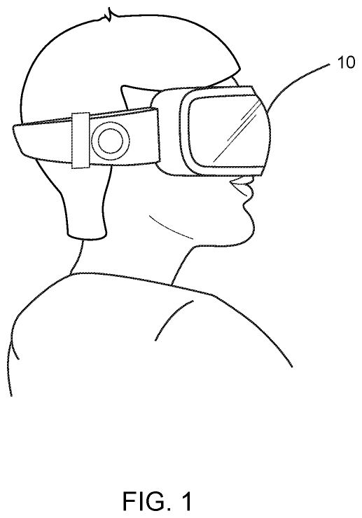

### Description of FIG. 1

FIG. 1 shows a non-limiting example diagram of a user wearing a virtual reality headset 10. In one non-limiting example, the technology described herein enables a user to view the virtual environment depicting property using a virtual reality headset 10 to provide further immersion into the virtual environment. It should be appreciated that the technology is not limited to using virtual reality and envisions any variety of implementations including a regular virtual three dimensional space displayed on a conventional display (e.g., a monitor), holographic systems, and/or augmented reality systems.

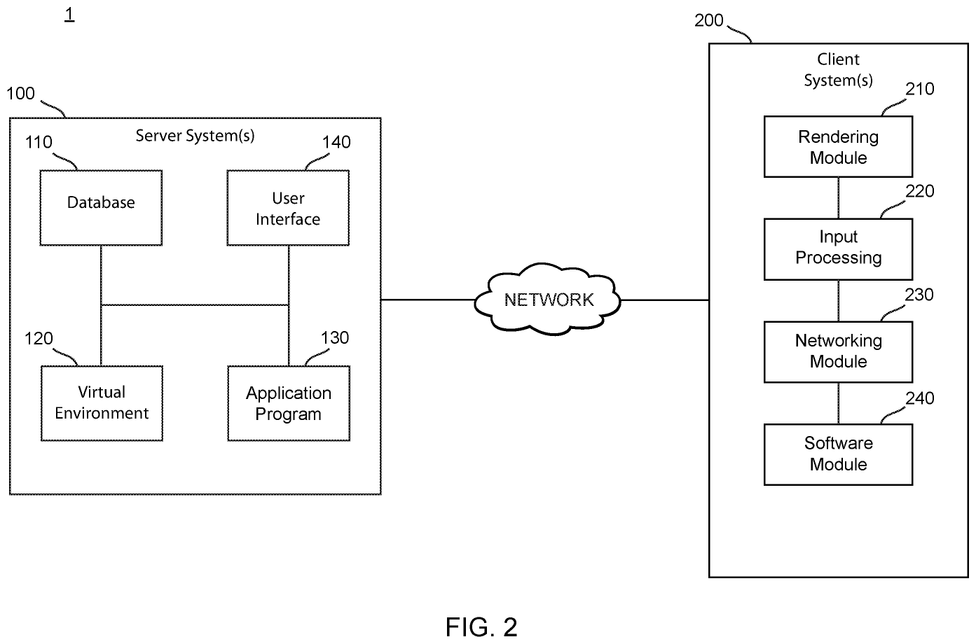

### Description of FIG. 2

FIG. 2 shows a non-limiting example block diagram of a system 1 wherein the framework for generating a simulated environment can be implemented. In one non-limiting example, the system 1 may include server system(s) 100 and/or client system(s) 200. The server system(s) 100 and client system(s) 200 can communicate with each other (e.g., via a network) where various data can be transmitted and received between the systems.

FIG. 2 shows software modules (such as the rendering module 210) executing at the server system(s) 100 and client system(s) 200; it should be understood that the software modules shown in FIG. 2 are stored in and executed by hardware components (such as processors and memories). In one non-limiting example, the server system(s) 100 are configured to produce data for generating the simulated environment at the client system(s) 200. For example, the server system(s) may include a database 110 for storing data associated with the virtual environment. In one example, database 110 may store information related to identifying different users and/or properties as well as other information for producing the virtual environment. The database 110 may be or include one or more of: a relational database management system (RDBMS); an object-oriented database management system (OODBMS); an object-relational database management system (ORDBMS); a not-only structured query language (NoSQL) data store; an object cache; a distributed file system; a data cluster (based on technology such as Hadoop); and/or any other appropriate type of data storage system).

Server system(s) 100 may also include a virtual environment 120 for generating the virtual 3-D environment. In one example, the virtual environment 120 may be defined by a three-dimensional coordinate system where different items and textures comprise portions of the three-dimensional coordinate system.

The server system(s) 100 may further include an application program 130 for generating a software application of the simulated environment. In one non-limiting example, the application program 130 may contain data for executing a program associated with the simulated virtual environment where the program 130 may interact with the different modules (e.g., virtual environment 120) in the system 100. The server system(s) 100 may further include a user interface 140 for generating a user interface associated with the simulated environment. In one non-limiting example, the user interface 140 may generate data for creating a visual representation of the simulated environment as well as other visual displays.

In one non-limiting example, client system(s) 200 may receive data from server system(s) 100 containing information for generating the simulated environment. In doing so, client system(s) 200 can utilize certain software framework for creating a visual depiction of the environment and then enable the user to interact with the environment. More specifically, client system(s) 200 includes at least rendering module 210. In one non-limiting example, rendering module 210 can render the virtual 3-D environment for display on a display associated with client system(s) 200. For example, the server system(s) 100 may transmit data associated with the virtual environment and represented in a three-dimensional coordinate plane. The rendering module 210 may then convert the data so that it can be rendered as a virtual 3-D space on a two dimensional display (e.g., using a two dimensional coordinate plane). The rendering module 210 will thus generate data for display on a display device associated with system(s) 200. For example, the rendering module 210 will generate data for display on a display of a virtual reality headset and/or a display connected to a user terminal. This example is of course non-limiting and the technology described herein envisions any variety of techniques for displaying the rendered data.

The system(s) 200 may also include input processing 220 for accepting and processing user inputs. For example, a user may operate a controller associated with system(s) 200 for moving a virtual character around in the virtual environment. Inputs received from the controller can be processed by input processing 220 and then the virtual environment may be updated depending upon the input received and processed.

Client system(s) 200 may also include a networking module 230 for communicating with server system(s) 100. In one non-limiting example, the networking module 230 can implement one or more networking/communication protocols, and can be used to handle various data messages between the system(s) 100 and 200. In one non-limiting example, the networking module 230 may carry out a socket connection by using a software connection class to initiate the socket connection between devices. Once the sockets are connected, networking module 230 may transfer data to/from the server system 100.

Client system(s) 200 may also include software module 240. In one example embodiment, the software module 240 can be used to execute various code loaded at the client system(s) 200, and perform other functionality related to the software. The software module 240 may be, for example, a Java runtime engine or any other type of software module capable of executing computer instructions developed using the Java programming language. This example is of course non-limiting and the software module 240 may execute computer instructions developed using any variety of programming languages including, but not limited to, C, C++, C #, Python, JavaScript, or PHP.

It should be appreciated that the components shown in FIG. 2 can be implemented within a single system. The components could also be incorporated in multiple systems and/or a distributed computing environment (e.g., a cloud computing environment). Thus, the system is not limited to a single component and can be incorporated into multiple components.

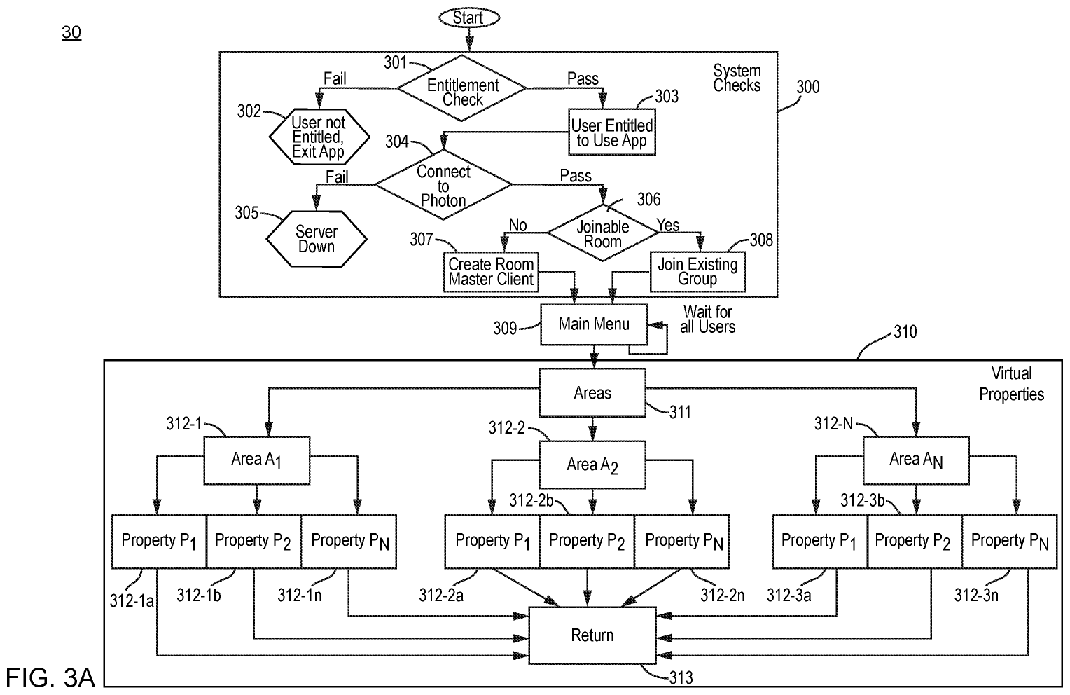

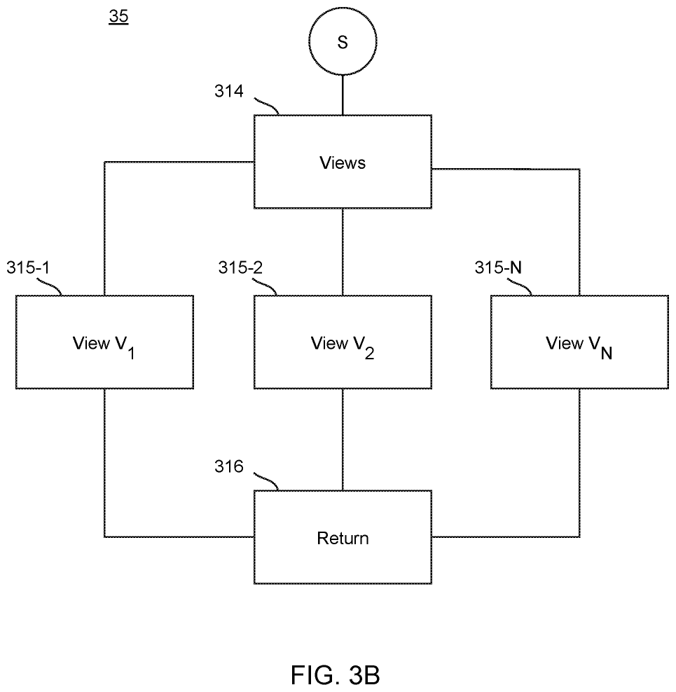

### Description of FIGS. 3A & 3B

FIG. 3A shows a non-limiting example flowchart 30 showing a flow of processes for the technology described herein. The process shown in FIG. 3A shows non-limiting example actions taken by the system for implementing the virtual reality application. The non-limiting example flowchart 30 includes two main sections: System Checks 300 and Virtual Properties 310. In one non-limiting example, System Checks 300 will perform an entitlement check, attempt to connect to the server, and manage all users. Virtual Properties 310 can represent an area that can be navigated to view properties.

The flowchart 30 demonstrates that a property exists for each Area 312-1-312-n and Property 312-1a-312-3n such that (A_1 P_1,A_1 P_2, . . . A_1 P_N), . . . (A_N P_1,A_N P_2, . . . A_N P_N), where A1=first property, A2=second property, AN=Nth property, etc. development or realty. The process begins with the application performing an entitlement check (S301). In one non-limiting example, the entitlement check is required by Oculus to verify application entitlement, this is performed by calling ‘Core.Initialize( )’. Once initialization is complete, Oculus will send a callback which must be handled, then user data can be obtained through a similar process.

During the entitlement check, the system will perform an authentication process to determine if the user is entitled to use the application. If the user is denied authorization, the process proceeds to exit the application (S302) where if the user is granted authorization, the system determines that the user may use the application (S303) and will proceed with further processing.

Upon determining that the user is entitled to use the application, the system will then initialize and attempt to connect to the Photon Network (S304). If the connection is not established, the system will determine that the process failed (S305) and note that the server may be down. For example, the server may be down or may not have access to the internet at the given point in time. If the connection does establish, the system will complete the connection to the network.

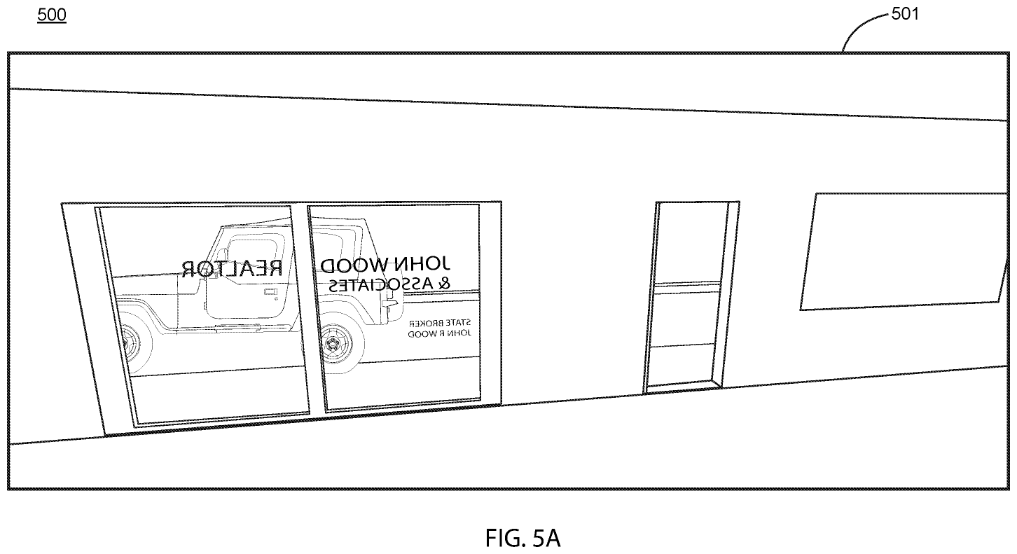

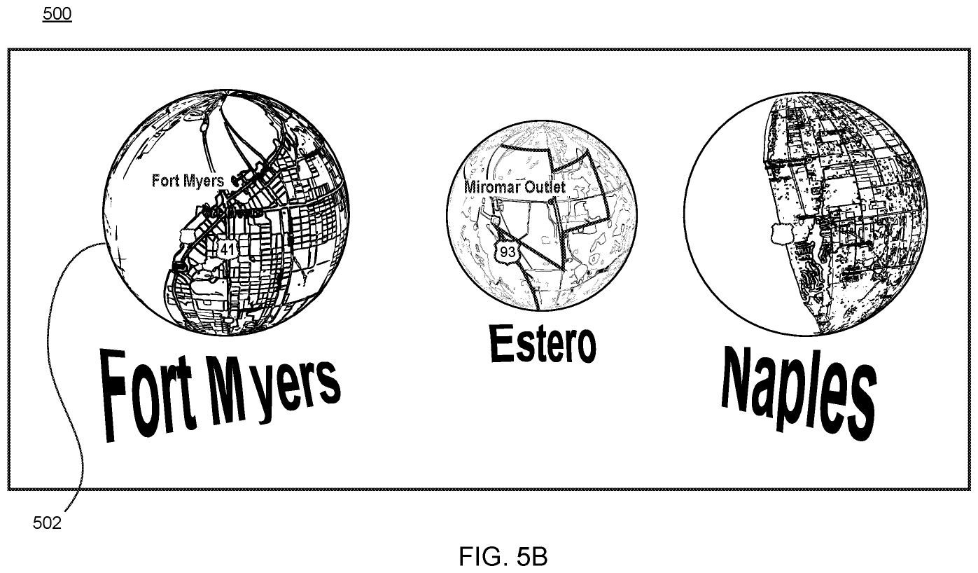

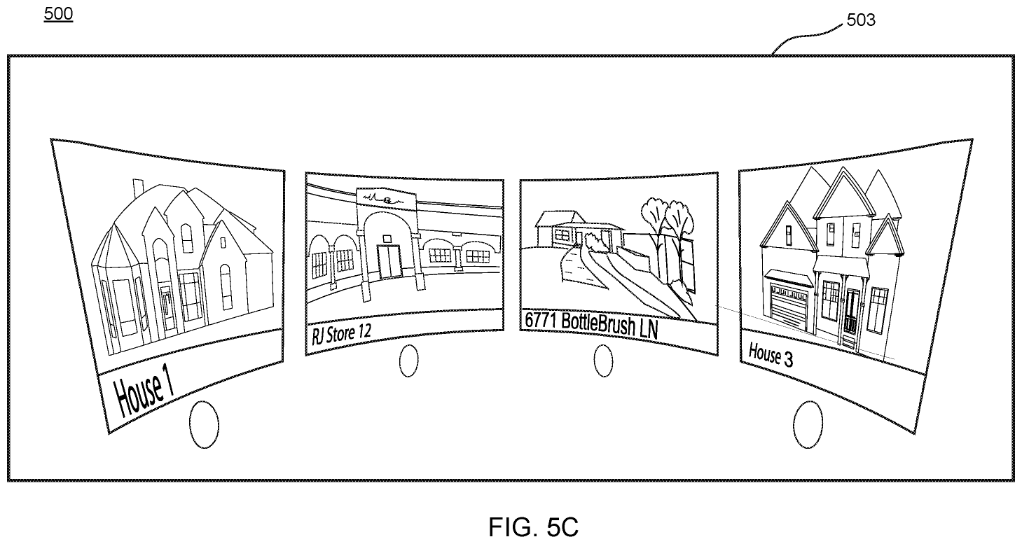

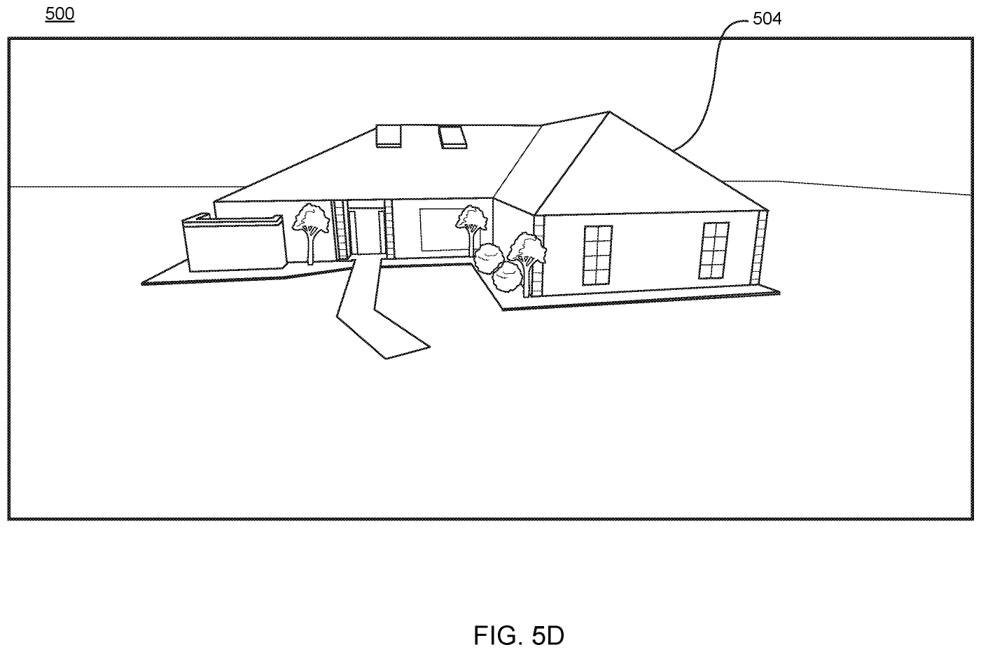

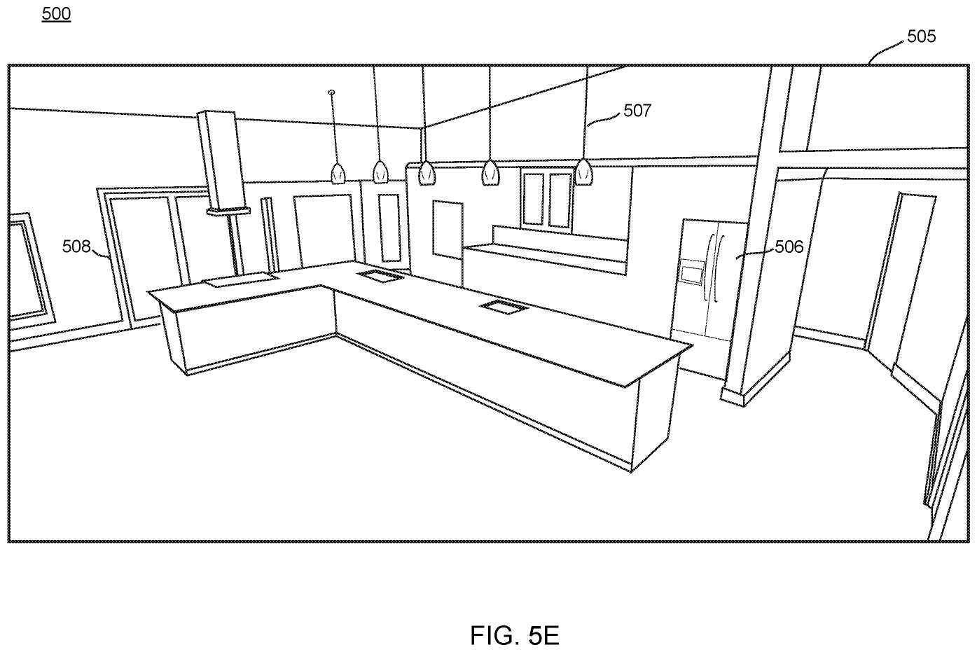

In one non-limiting example, connecting to the Photon Network is handled in script by calling the method ‘PhotonNetwork.ConnectUsingSettings( )’ and including the required settings. If the application fails to connect to the network, a virtual room cannot be created to handle the multiple client connections, thus causing the application to wait and then timeout. Upon successful connection, the system will determine if there is a joinable room (S306). If there is no current open room to join, the client system will become a Master Client and a new room will be created (S307). Once the room has been created, the Master Client will load the Main Menu scene (S309) and become joinable by other users. On the other hand, if a joinable room exists, the client system will join an existing group (S308) and will similarly proceed to the main menu screen (S309) to potentially join with other users. An example main menu scene is shown in at least FIG. 5D, and discussed in further detail below.

From the menu screen, the system can advance to the Virtual Properties 310. In one non-limiting example, Virtual Properties 310 will constitute one or more virtual real properties the user can virtually visit/view. In one non-limiting example, the system will generate a display showing different areas (S311) that can be divided into multiple areas (S312-1-312-n). In one example, these areas will be geographically divided (e.g., a Fort Myers area, an Estero area, a Naples area) as discussed in more detail below. Upon selecting an area, the system can generate a display showing different properties (S312-1a-312-3n) in each respective area. An example of different properties that can be displayed/viewed are discussed further below. Once the process ends, the system may return to the Main Screen (S313) where the user may then exit the application.

It should be understood that, although actions 301-313 are described above as separate actions with a given ordering/sequence, this is done for ease of description. It should be understood that, in various embodiments, the above-mentioned actions may be performed in various orderings/sequences; alternatively or additionally, portions of the above-described actions 301-313 may be interleaved and/or performed concurrently with portions of the other actions 301-313.

FIG. 3B shows a non-limiting example flowchart 35 showing a flow of processes for the technology described herein. The process shown in FIG. 3B shows non-limiting example actions taken by the system for implementing the virtual reality application. In particular, the flowchart 35 depicts a process for switching viewpoints in the virtual environment.

As mentioned briefly here, much like the CAD file, this application will pass through many hands moving from designer, architect, developer, construction, electricians, plumbers, and others. Therefore, a need exists for the application to make sense to all these different types of personnel. In order to achieve this objective, the technology further includes multiple ‘viewpoints’ which will contain information specific to an individual process. For example, the electrical viewpoint will contain nomenclature familiar to an electrician. This will allow the electrician to switch easily between the viewpoints to see specific information about an object shown in the building. This could be an outlet, shown in the normal viewpoint, and after switching to the electrical viewpoint the application could reveal more intricate details to the user.

The process begins by initially displaying one of the viewpoints (S314). For example, the virtual environment may be displayed in a “normal viewpoint” showing the interior and exterior of the structure as one would see in a fully built structure. That is, the “normal viewpoint” may correspond to a house that is fully built (e.g., walls, doors, ceiling).

The process can then proceed to any of the alternate viewpoints View V1-Vn (S315-1-315-n). For example, the process may switch between the “normal viewpoint” to the “plumbing viewpoint” where the view will change from showing the fully built structure to one that shows an interior view of the plumbing system. Likewise the process may switch to another viewpoint, such as the “electrical viewpoint,” where the view will change to show an interior view of the electric configuration of the structure. The process can return and switch to alternate viewpoints (S316).

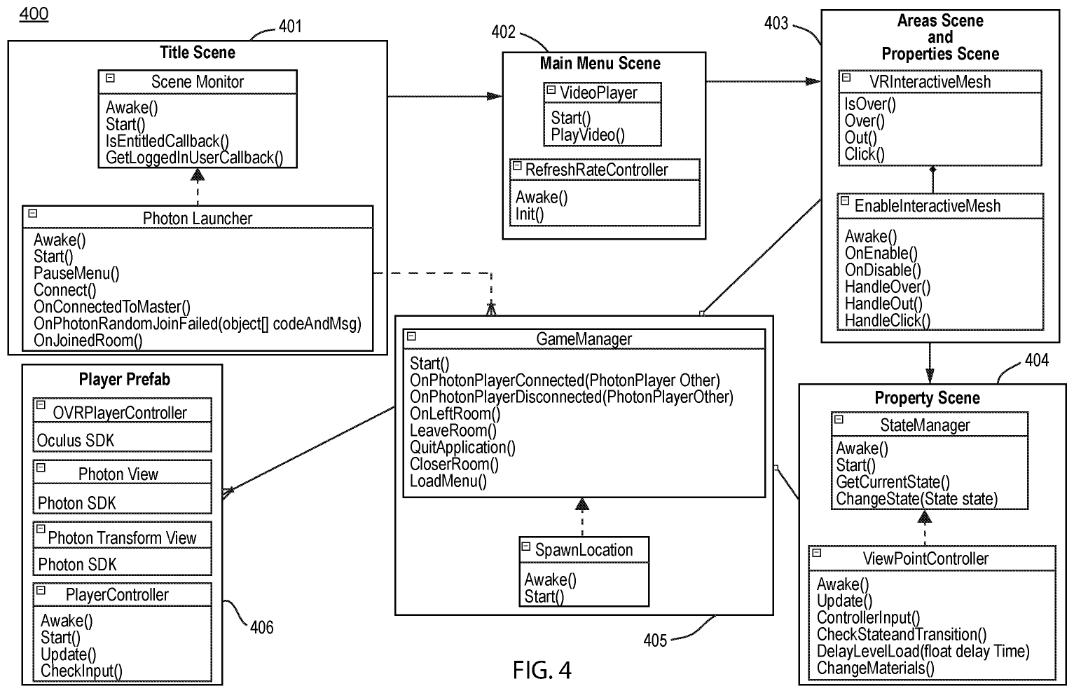

### Description of FIG. 4

FIG. 4 shows a non-limiting example diagram of an application design and workflow 400. The example shown in FIG. 4 depicts various software routines and/or libraries for generating certain aspects of the user interface. In one example, the different routines, classes, and/or libraries may be used in generating different scenes associated with the simulated virtual environment.

In one example, the initial scene for the application is the Title scene 401, which can utilize two classes. The first class, Scene Monitor, will perform the necessary entitlement check for the application. The second class, PhotonLauncher, is responsible for initializing the connection to the Photon server. Once both classes have completed and passed their requirements, the next scene can be loaded which, in certain example embodiments, could constitute the Main Menu scene 402.

The Main Menu scene 402 consists of two classes, VideoPlayer and RefreshRateController. The VideoPlayer class can utilize a raw image, already placed in the scene, as a display for the video. This class can also stream the audio data from the video file to the user. The second class, RefreshRateController, can apply the FFR (Fixed Foveated Rendering) to the headset to optimize the workload between the Graphics Processing Unit (GPU) and the Central Processing Unit (CPU).

The next two scenes, Areas and Properties 403, can use the same four classes allowing them to overlap in the class diagram. Items placed in these two scenes need to be interactable by the user where the classes EnableInteractiveMesh and VRInteractiveMesh assist in this process. The EnableInteractiveMesh class can be applied to an object with a mesh and a collider, making the collider searchable by a gaze pointer from the camera rig. The VRInteractiveMesh class can scan with a gazer until it interacts with a collider where it then may check the collider for an interactable tag. If the tag is found, the system will apply the appropriate settings to the mesh, such as changing color. The second two classes can be shared across all subsequent scenes and assist in synchronizing user's rotation, position, and status. GameManager 405 assists in prefab instantiation, network connection, scene changing, and user status. If a user has not been assigned a user prefab, which will represent the position of the user in VR, the GameManager 405 will instantiate one. Once a user joins the group, all users come together in the Main Menu scene 402. This allows a central location for the users to combine inside a single scene and from there all users can change scenes together. If a user decides to disconnect from the application, the GameManager 405 can send a network request to remove the user. SpawnLocation 405 receives the appropriate location and rotation for users to start a scene. This class can search for all available users on ‘Awake( )’ and assign the initial location.

The Property scene 404 can contain the actual property for the user to view inside VR. All Property scenes 404 can contain two classes (previously explained) as GameManager and SpawnLocation 405. These two classes provide the user with the options necessary to navigate to alternate scenes and to load in to a correct location near the property.

The Player Prefab 406 can be composed of four classes that coordinate the user position across the network and control user input from a controller. OVRPlayerController is provided by the Oculus SDK and is included on the Oculus Player Prefab. This class provides a list of options which can be configured for prefab settings as shown below:

PhotonView and PhotonTransformView are classes provided by PUN (Photon Unity Networking) which assist in synchronizing multiple users that exist in the same scene. PhotonView can serialize each user and provide the ability to easily determine if the user in question is the local host or local player instance. This assists in managing variables used across multiple classes as a quick reference to something, or to assign specific objects only to the local user. The latter is important for proper FPS (Frames Per Second) management. PhotonTransformView relates specifically to the user transform, which contains variables for position, rotation, and scale. PlayerController creates a reference to the local game object, which is used to assist with instantiation of user prefabs. This class will assign a camera rig, if necessary, and handle all user controller input. The classes and associated functions and libraries are discussed in further detail below.

As shown below, the SceneMonitor class initializes by calling ‘Core.AsyncInitialize( )’, then performs the entitlement check and waits for the callback message:

void Awake( )
{

Core.AsyncInitialize( );

}
void Start( )
{

Entitlements.IsUserEntitledToApplication( ).OnComplete(IsEntitledCallback);

}

The entitlement check will receive the callback message stating either check failed or check passed, as shown below:

void IsEntitledCallback(Message msg)
{

if (msg.IsError)
{

UnityEngine.Application.Quit( );

}

If the message is in error, the application will shut down, else, it will continue to run. PhotonLauncher will assign initial necessary network settings, then attempt to connect to the network, as shown below:

public void Connect( )
{

// keep track of the will to join a room, because when we come back
from the
// game we will get a callback that we are connected, so we need to
know what to do then
isConnecting = true;
// check if we are connected or not, we join if we are , else| initiate
the connection to the server.
if (PhotonNetwork.connected)
{

// #Critical we need at this point to attempt joining a Random
Room.
// If it fails, we'll get notified in OnPhotonRandomJoinFailed( )
and we'll create one.
PhotonNetwork.JoinRandomRoom( );

}
else
{

// #Critical, we must first and foremost connect to Photon
Online Server.
PhotonNetwork.ConnectUsingSettings(_gameVersion);

}

}

The connection method (‘Connect( )’) will perform a check to determine connection status, if connected to the network attempt to join a room. If not connected, then connect. Photon will send information back as a callback which can be handled by defining specific callback methods as shown below:

#region Photon.PunBehaviour CallBacks
public override void OnConnectedToMaster( )
{

if (isConnecting)
{|

PhotonNetwork.JoinRandomRoom( );

}

}

Once the network has connected, a callback is executed to confirm, and the user is able to join a room if one is available. The process depicted below demonstrates joining a random room has failed, or one is not available:

public override void OnPhotonRandomJoinFailed(object[ ] codeAndMsg)
{

Debug.Log(“OnPhotonRandomJoinFailed( ) was called by PUN.
No random room available, so we create one.”);
RoomOptions roomOptions = new RoomOptions( ) { MaxPlayers =
this.maxPlayersPerRoom };
PhotonNetwork.CreatRoom(null, roomOptions, null);

}

The process of failing to join a random room (or if a room is not available) can likely occur if no room has been created or no room is joinable due to a Master Client having a complete group and closing the room. A callback will be received and handled, then a new room will be created.

The code shown below demonstrates a room has been joined and that user is now a Master Client and becomes joinable by other users:

public override void OnJoinedRoom( )
{

Debug.Log(“OnJoinedRoom( ) called by PUN. ”);
PhotonNetwork.LoadLevel(“MainMenu”);

}

The current user will immediately load the Main Menu scene and either wait on the rest of the group or close the room and continue. When preparing the Main Menu scene, the RefreshRateController class utilizes the OVRManager class which comes with the Oculus SDK. Defining a specific rendering mode will improve the overall utilization between the GPU and the CPU. The modes available are ‘LMSLow’, ‘LMSMedium’, and ‘LMSHigh’. This application is considered heavy CPU and GPU due to reaching levels of utilization of CPU 3 and GPU 4, which hinders the rendered FPS. By making a call to the OVRManager, ‘OVRManager.tiledMultiResLevel=OVRManager.tiledMultiResLevel.LMSHigh’, the GPU receives a greatly improved boost to performance, allowing the CPU to increase only slightly but the GPU to drop significantly and FPS to increase significantly. Care must be taken to avoid setting the FFR in a scene with low CPU and GPU utilization, as this will cause more overhead instead of improvement. Additionally, the display frequency can be queried and set if desired, as shown below:

void init( )
{

OVRManager.tiledMultiResLevel =
OVRManager.TiledMultiResLevel.LMSHigh;
//OVRManager.display.displayFrequency = 72.0f;

}

When preparing the Areas and Properties scene, these two scenes use the same classes, as demonstrated in the diagram FIG. 4. The GameManager will initialize on scene start, which will first create an instance then check the network connection. If the network is not connected, ‘SceneManager.LoadScene(0)’ is called which will load the Title scene and attempt to connect to the Photon Network. This process is demonstrated in the code shown below:

void Start( )
{

Instance = this;
// in case we disconnect from server, simply load the menu scene
if (!PhotonNetwork.connected)
{

SceneManager.LoadScene(0);
return;

}

The GameManager will then check the Local Player Instance to determine if it is null, and if so, instantiate a user prefab as shown below:

if (PlayerController.LocalPlayerInstance == null)
{

Debug.Log(“We are Instantiating LocalPlayer”);
// we're in a room. spawn a character for the local player.|
PhotonNetwork.Instantiate(this.playerPrefab.name, new Vector3(9.5f,
4f, −23f), Quaternion.identity, 0);

}

This class is maintained throughout all subsequent scenes and is responsible for any user leaving or connecting to the network. If a user decides to leave the group, ‘OnLeftRoom( )’ will be called and that user will load the title scene to continue the application as a single user with the opportunity to lock their room. This process is shown in the code below:

public override void OnLeftRoom( )
{

SceneManager.Loadscene(0);

}

If a new user joins the group, all group members will load the Main Menu scene to synchronize. From there, all users can move throughout the scenes as a group as demonstrated below:

public override void OnPhotonPlayerConnected(PhotonPlayer other)
{

// not seen if you're the player connecting
Debug.Log(“OnPhotonPlayerConnected( ) ” + other.NickName);
if (PhotonNetwork.isMasterClient)
{

// called before OnPhotonPlayerDisconnected
Debug.Log(“OnPhotonPlayerConnected isMasterClient ” +
PhotonNetwork.isMasterClient);
LoadMenu( );

}

}

It should be appreciated that the Master Client (e.g., realtor) can close the room after the desired group is loaded on the network or risk being brought back to the Main Menu scene and picking up an extra user. If a user decides to quit the application, ‘OnPhotonPlayerDisconnected( )’ is called so the user can exit without causing problems for the rest of the group as demonstrated below:

public override void OnPhotonPlayerDisconnected(PhotonPlayer other)
{

Debug.Log(“OnPhotonPlayerDisconnected( ) ” + other.NickName);
// seen when other disconnects
if (PhotonNetwork.isMasterClient)
{

// called before OnPhotonPlayerDisconnected
Debug.Log(“OnPhotonPlayerConnected isMasterClient ” +
PhotonNetwork.isMasterClient);
LeaveRoom( );

}

}

Once all users have joined the group, the Master Client will initiate closing the group. This prevents others from joining and allows new rooms to be virtualized as shown below:

public void CloseRoom( )
{

PhotonNetwork.room.IsOpen = false;

}

The second class used in both scenes is the SpawnLocation class. This class is initiated in the ‘Awake( )’ method and searches for all user prefabs loaded into the scene. For each prefab found, the appropriate transform location and rotation is assigned. These coordinates, in vector form, are associated to an empty game object placed in the scene and referred to in the class as ‘GameObject spawnLocation’ as shown below:

The third and fourth classes used in both scenes are EnableInteractiveMesh and VRInteractiveMesh. EnableInteractiveMesh is added to any game object in the scene that requires user interaction. If the user is ‘gazing’ at the interactable item(s), a specific event will trigger allowing further manipulation. VRInteractiveMesh uses private variables to manipulate the Mesh Renderer by changing the material (color) of the game object that is assigned the EnableInteractiveMesh script. This color change process allows the user to conclude that they are looking at an interactable item and then interact. In this case, the interactable item will load the entire group to the next scene, ‘6771BottleBrushLN’. The mesh manipulation options and desired settings for a specific game object are shown below:

As the class diagram shows (e.g., in FIG. 4) Logical Viewpoint, this scene utilizes two classes previously explained, GameManager and SpawnLocation. The GameManager will assist in coordination between all users and the Photon Network, while SpawnLocation will determine position and rotation on scene load. The property scene represents all available properties which can be viewed as explained herein. Once all users are satisfied, the Master Client can transition the entire group back to an area to view another property.

The Property Scene 404 can also include a Structure Viewpoint having at least two classes: StateManager and ViewPointController. These classes can work together to control the state of the application and modify the structures according to the current state. The class ‘StateManager’ can maintain any one of many possible states, some of which are shown below:

public enum State
{
. // The initial State, displays unmodified version of structure
. NORMAL_VIEWPOINT,
. // Adds translucent materials to walls, floor, and ceiling to view
. // internal plumbing components
. PLUMBING_VIEWPOINT,
. // Displays symbols similar to CAD markings, located in 3D structure
. // positioned as desired by developer
. ELECTRICAL_VIEWPOINT
};

The class also can contain methods to query the current state or change the current state. Some examples of such an approach are shown below:

public static State CurrentState
{

get

{ return s_manager.m_currentState; }|

}
public static void ChangeState (State state)
{

```
  if (s_manager.m_currentState != state)
  {
```

s_manager.m_currentState = state;

}

}

The second class (e.g., ViewPointController) can control what modifications need to take place by querying the current state. In one non-limiting example, this class may be called to perform a state query based on certain user input (e.g., if a right trigger on a handheld controller is activated). Once called, a switch statement can determine the current state, make necessary adjustments, then set the new state for additional queries. An example of such an implementation is shown below:

switch (StateManager.CurrentState)
{

case StateManager.State.NORMAL_VIEWPOINT:

StateManager.ChangeState(StateManager.State.PLUMBING_VIEWPOINT);
// Change materials to translucent
ChangMaterials( );|
break;

case StateManager.State.PLUMBING_VIEWPOINT:

StateManager.ChangeState(StateManager.State.ELECTRICAL_VIEWPOINT);
// change to Electrical structure
structare1.SetActive(false);
structure2.SetActivc(true);
break;

case StateManager.State.ELECTRICAL_VIEWPOINT:

StateManager.ChangeState(StateManager.State.NORMAL_VIEWPOINT);
// Change back to Normal structure
structure2.SetActive(false);
structura1.SetActive(true);
break;

}

This process can be repeated and configured to again receive input and react based on the current state. The viewpoints currently implemented are as follows: Normal Viewpoint, Plumbing Viewpoint, and Electrical Viewpoint. These examples are of course non-limiting and the technology envisions any variety of viewpoints including, but not limited to, a first person viewpoint, a third person viewpoint, a birds eye viewpoint, a dynamic interior to exterior swapping view, a dynamic exterior to interior swapping viewpoint, a two dimensional floorplan viewpoint, and/or a three dimensional floorplan viewpoint, among others. It should be appreciated that these example views discussed above can provide detail not normally seen by an individual viewing a structure and/or seen from a different perspective. Such an approach enables easy viewing of the exterior and interior components of the structure as the developer intends and allows for a much more proficient development process. The software framework described herein can of course be used to generate the simulated virtual environment that creates the user interfaces discussed in further detail below.

### Description of FIGS. 5A-E

FIGS. 5A-E show non-limiting example embodiments of user interfaces 500 for generating and/or displaying the simulated environment. The examples shown in FIGS. 5A-E depict different user interfaces 500 that are generated for the process related to selecting areas for viewing property. In one non-limiting example, the user interfaces 500 can be viewed as the user wears a virtual reality device so that the environment will appear as though the user is navigating a real building. This example is of course non-limiting and the user interfaces 500 may be displayed on any particular display device (e.g., computer monitor, phone, television).

FIGS. 5A-E specifically show different user interfaces 500 that allow the user to participate in the overall viewing/navigation process of the virtual environment. In one non-limiting example, the user interface 500 may begin by generating a virtual office 501. For example, virtual office 501 may be generated to appear similar to a realtor office for selling/buying/renting real property.

In one non-limiting example, virtual office 501 may represent a “Main Menu” office where a user can virtually “visit” the office and the office 501 can serve as a staging area for all group members that may want to view/navigate the different properties. In the example shown in FIG. 5A, an example 1960's office building is displayed that includes a “JRW” (John R Wood) Jeep, and the 1960's Naples Rexall. The virtual office 501 may be a scene for all users to join that will participate in a VR session and once the group has joined the area, the “Master Client” (e.g., first user to create the room) will close the room so other users cannot join the group. This work flow allows the user unfamiliar with typical ‘create session’ and ‘join request’ applications to easily integrate. In one non-limiting example, it may be the responsibility of the “Master Client” (e.g., a realtor) to close the room once all users have arrived so that the room becomes un-joinable by other users and allows flow to continue for others. Each user joining the session can receive a “Photon View” script which allows the “Master Client” to change scenes with the entire group. Throughout the entire process, only the “Master Client” may have the capability to progress the group through the scenes. This can be done, for example, to give control to the “Master Client” (e.g., realtor) to keep the group from getting separated or moving on their own. The user interface 500 may also include a non-playable character (NPC) that exists at each property to perform the walkthrough without a realtor having to be present.

FIG. 5B shows another non-limiting example user interface 500 depicting different “globes” that are generated that correspond to respective areas 502. As shown in FIG. 5B, for example, the areas 502 implemented are Fort Myers, Estero, and Naples (e.g., all areas in the state of Florida). It should be appreciated that the areas 502 displayed are not limited to these specific areas and other implementations could include, for example, Bonita Springs and Marco Island (among any other).

It should be appreciated that each “globe” can include an ‘Enable Interactive Item’ script which allows the “Globe Collider” to become interactable when ray cast by the VR headset, for example. In one non-limiting example, when a user hovers over an area 502, the letters below the “globe” can change color to inform the user they are hovering over that object. If the user then decides to enter that area 502, they can push a button on a controller and the corresponding scene will be loaded for the entire group. Another embodiment could place the “globes” inside a Main Menu office (e.g., inside a separate room).

FIG. 5C shows another non-limiting example interface 500 for selecting different properties to view within a specific area. After selecting an area 502, the user will be brought to the properties scene with one or more properties 503 as shown, for example, in FIG. 5C. In the example shown in FIG. 5C, users can select the desired property 503 where, in the example shown, four choices exist. For example, properties 503 may refer to properties currently “on the market” and for sale, or could refer to properties that may be recently sold (or will be “on the market” in the near future). This example is of course non-limiting, and properties 503 could include prospective properties that have not been built yet (or are in the process of being built).

FIG. 5D shows another non-limiting example user interface 500 depicting a view showing exterior property 504. In the example shown in FIG. 5D, the exterior property 504 is shown from an exterior view where the user can navigate different areas outside of the exterior property 504. For example, the user can walk around the outside of exterior property 504 to view, among other features, exterior surfaces of the exterior property 504, landscape, walkways, and/or how certain environmental conditions affect the exterior property 504.

In one non-limiting example, the scene shown in FIG. 5D may be generated after a user selects a property 503 shown in FIG. 5C. For example, a user may select “House 1” shown in FIG. 5C, and then the interface 500 will change so that the user will be “transported” to the exterior property 504 shown in FIG. 5D. In one non-limiting example, interface 500 may transition directly from the scene shown in FIG. 5C to the exterior property 504 shown in FIG. 5D, for example, by appearing as though the user walks toward and into the property 503 selected from FIG. 5C.

FIG. 5E shows another non-limiting example user interface 500 displaying interior property 505. In one non-limiting example, a user may navigate a virtual character in the virtual three-dimensional space to move the virtual character from the exterior of the property (shown, for example, in FIG. 5D) into the interior property 505. For example, the user may navigate the virtual character into the property through a virtual door of the virtual property. This example is of course non-limiting and the user may bring the virtual character into the property by any means including, but not limited to, directly entering the interior property 505 when the user interface 500 is rendered, directly entering the interior property 505 when the user selects a specific location (e.g., from the virtual office scene), and/or entering the property through another entrance (e.g., a window).

The interior property 505 can show any aspect of an interior structure. In the example shown in FIG. 5E, the interior property 505 in user interface 500 shows an example virtual kitchen in the virtual three-dimensional space. The example virtual kitchen could include any variety of items typically found in a kitchen including, for example, appliances such as virtual refrigerator 506 as well as any other variety of items including at least stoves, ovens, sinks, microwaves, tables, chairs, cabinets, and pantries, among other items.

The example virtual kitchen shown in FIG. 5E further includes lighting 507 that can virtually illuminate the interior property 505. The lighting 507 may be used to show how different light fixtures can illuminate interior property 505 so the user has a perspective as to how the interior property 505 will look under artificial lighting conditions. Interior property 505 further includes other aspects of the structure including windows and doorway 508 where the user can virtual enter and/or exit the interior property 505 to move to the exterior property 504.

It should be appreciated that interior property 505 can show any aspect of an interior structure including, but not limited to, master bedrooms, regular bedrooms, regular bathrooms, master bathrooms, basements, closets, hallways, stairways, attics, crawlspaces, family rooms, living rooms, dining rooms, and/or home offices, among other spaces. Moreover, the interior property 505 and exterior property 504 shown in these example figures depict a single family residential house. However, the properties are not limited to such and could be any type of structure including commercial buildings, apartment buildings, condominiums, and/or portable homes, among other aspects. As discussed in further detail below, different aspects of the properties may be modifiable/customizable by a user.

As discussed herein, the virtual 3-D environment provides the user with a realistic experience for touring the virtual home. In certain example embodiments, the user can perceive how different natural light affects the interior of the home. The user may also be able to interact with the environment by, for example, opening doors/cabinets, turning on/off lights, turning on/off water, and/or opening/closing windows, among other aspects. Moreover, the user can perceive how different weather effects and/or environmental effects (e.g., rain, snow, wind) can affect the property.

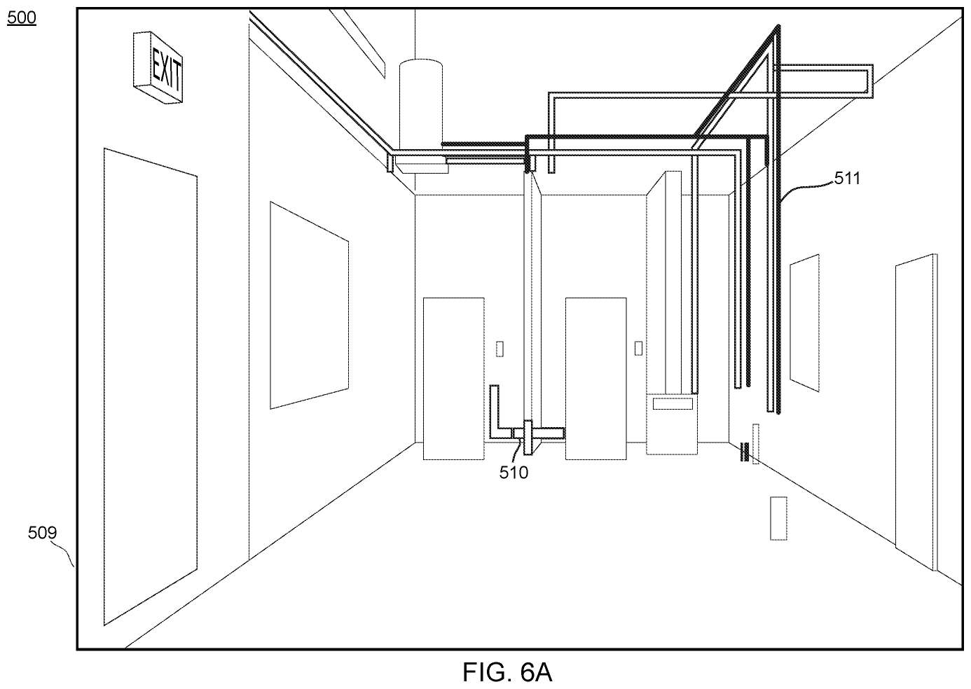

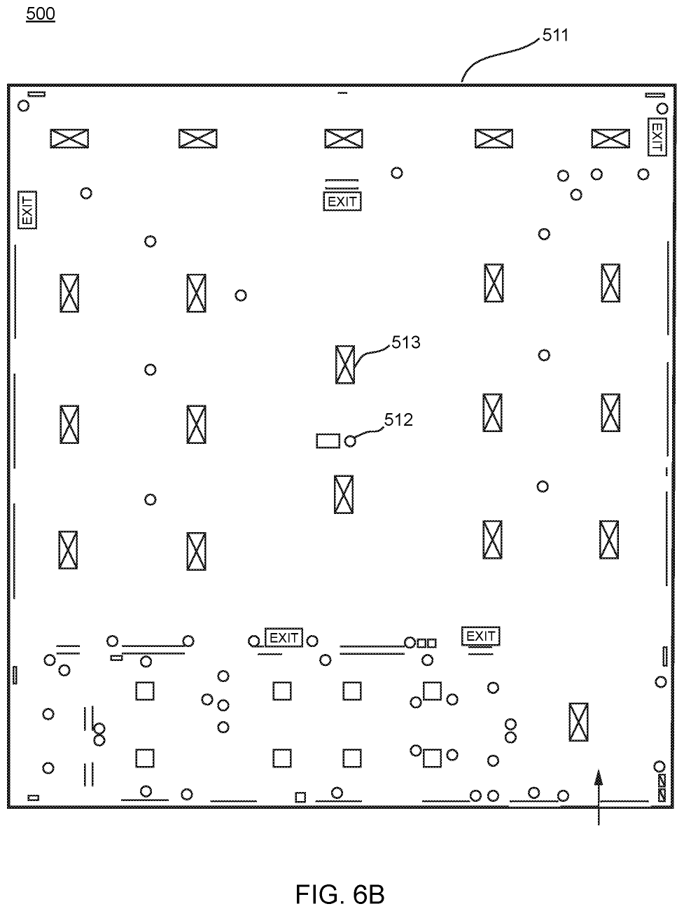

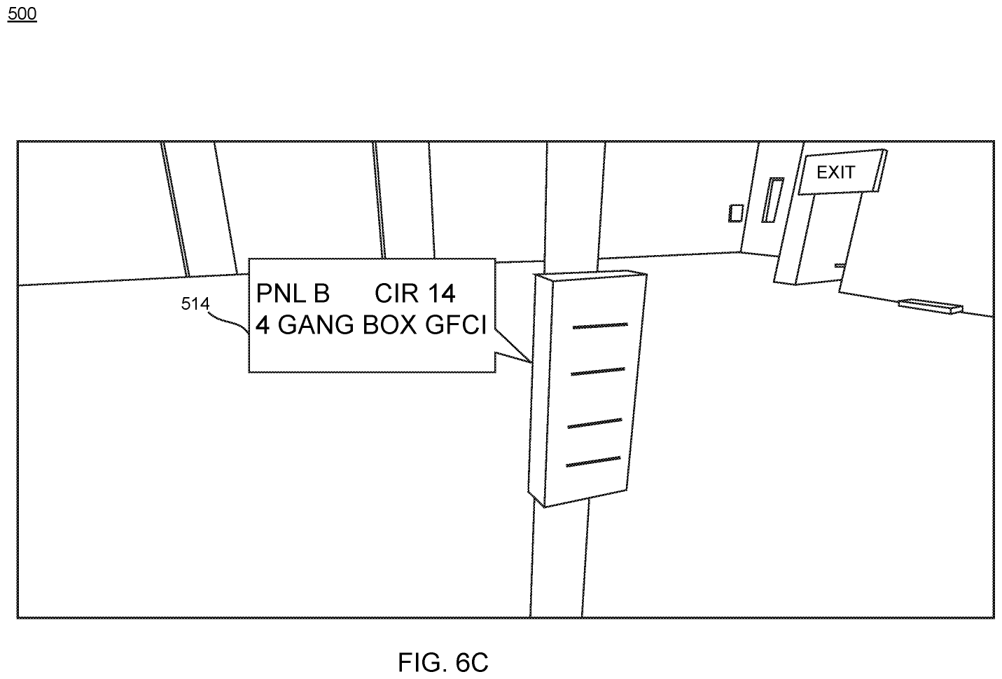

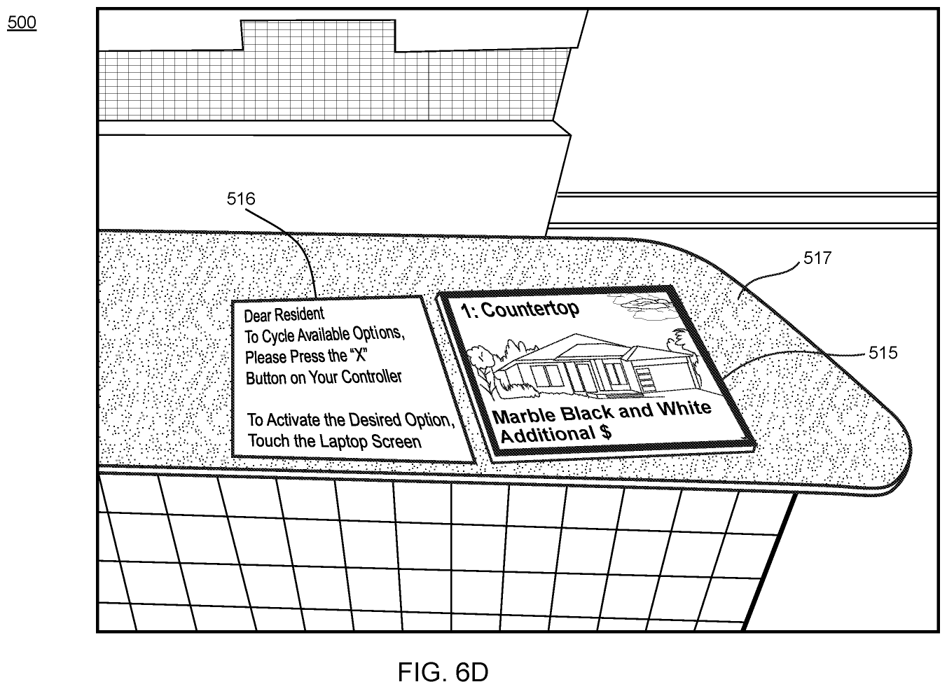

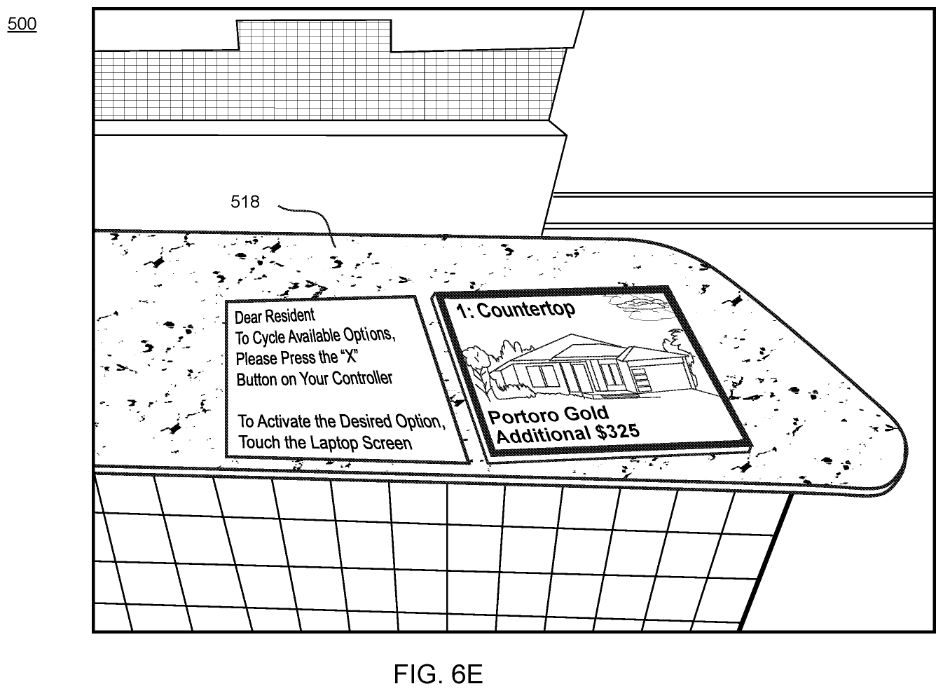

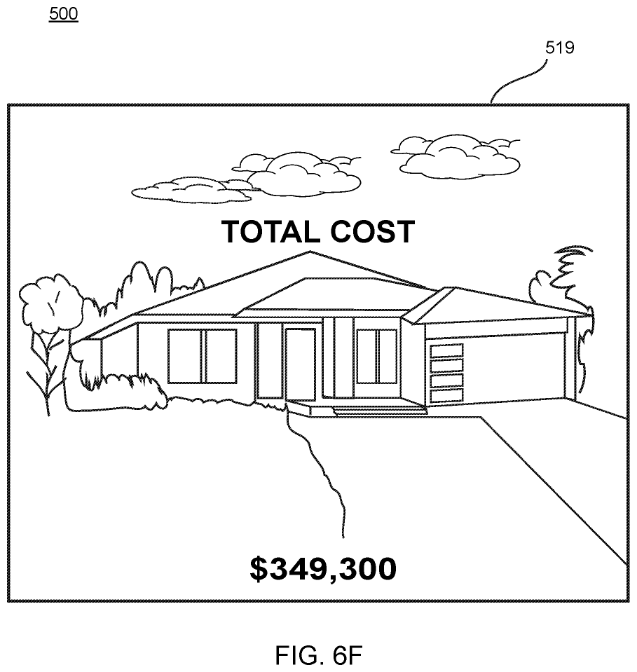

### Description of FIGS. 6A-F

FIGS. 6A-F show non-limiting example interfaces 500 for the simulated environment. In the examples shown in FIGS. 6A-F, the user interfaces 500 depict different aspects of the simulated environment that allow the user to change views of the environment as well as customize aspects of the environment. In one non-limiting example, FIGS. 6A-C show different modes for viewing the virtual environment while FIGS. 6D-F show different aspects related to environment customization.

FIG. 6A specifically shows an example user interface 500 showing a frame view 509 depicting a “skeleton” view of the structure. In one non-limiting example, the frame view 509 is depicted from the interior of the property in FIG. 6A but the technology described herein is not limited to such an example and frame view 509 can be seen from any aspect including an exterior view of the property.

In the frame view 509 shown in FIG. 6A, different elements comprising the internal structure (e.g., insides of walls) can be shown. For example, first plumbing 510 and second plumbing 511 are shown as comprising parts of the “skeleton” of the structure. The frame view 509 can also be accessed based on user input (e.g., pushing a controller button) to change from a “normal” view showing the property to the frame view 509 showing the “skeleton” of the property. It should be appreciated that the user may switch to an alternate view showing electrical components of the “skeleton” (e.g., rather than plumbing components). That is, the user may be able to “cycle” through different views based input to switch between a “normal view,” a “plumbing view”, and/or an “electrical view,” among other aspects. It should be appreciated that a “normal view” can be a view of what would “normally” be seen by the user, typically the interior and exterior of a structure. The “normal view” is useful in determining proper physical location, actual placement of objects, structure color, and design among other things. It should be further appreciated that “activating” the “plumbing view” (sometimes also referred to as a “sewer view”) allows the user to view the plumbing systems below the floor, in the walls, and in the ceiling, as a non-limiting example. Such a perspective can make clear the intended design of these systems and allow for quick changes if necessary. The “plumbing view” can include, but is not limited to, showing sewer, cold water, hot water, water heaters, lift stations, and/or anything used in the plumbing/sewer systems. It should be appreciated that similar features and benefits apply to the “electrical view” and the “electrical view” can include, but is not limited to, switches, outlets, conduits, circuit panels, lighting, and/or anything used in an electrical system.

FIG. 6B shows an example top down electrical view. In one non-limiting example, FIG. 6B shows an electrical plan 511 from a top down view where different elements in the plan 511 can show locations of different structures and/or electrical components. For example, plan 511 can include one or more outlet indicators 512 indicating the location of different electrical outlets. It should be appreciated that indicators 512 are not limited to electrical outlets and can indicate other electrical components including, but not limited to, switches, lighting/fan connections, and/or thermostat connections.

Plan 513 can include additional elements including structure indicators 513 indicating different structures that could include electrical components. For example, structure indicators 513 could indicate a wall or column containing electrical conduit traveling up/down the structure. These examples are of course non-limiting and the technology descried herein envisions any variety of elements that could be included in an electrical plan 513. It should be further appreciated that the top down electrical view can be generated based on user input as the user navigates the virtual environment. For example, the user could enter a room in the property and then provide an input (e.g., using a controller) that generates the view showing electrical plan 511 for the specific room in which the user's virtual character currently resides. In doing so, the user can easily view the electrical plan of the entire room and make any modifications to the plan as necessary.

FIG. 6C shows an example electrical view with a pop-up description. In one non-limiting example, user interface 500 of FIG. 6C shows a dialog box 514 providing different information related to an aspect of the structure in which the user is “viewing.” In the example shown in FIG. 6C, dialog box 514 shows a written description of a circuit box/panel that the user is currently viewing. In one non-limiting example, the application can utilize the “gaze” pointer described within certain aspects of this application. For example, the class ‘EnableInteractiveMesh’ can be placed on the electrical components to determine if the user is gazing at the component. If true, the dialog box 514 can appear describing essential information for that component, such as Panel (PNL) and Circuit (CIR). The “electrical view” can allow the structure and components to be seen without additional clutter from notes associated with each component. The user can view a specific component and the necessary information associated with it without being overcome by a significant amount of information.

FIGS. 6D and 6E show further non-limiting example user interfaces 500 where different elements of the environment may be customized. In one non-limiting example, different rooms in the property may include a virtual paper 516 that can include “written” instructions for operating a virtual laptop 515 in the virtual space. The virtual laptop 515 can be operated to allow the user in the virtual environment to change any options within the environment such as the flooring, refrigerator, cabinets, showers/bath, crown molding, baseboards, wall colors, and/or countertops. In the example shown in FIG. 6D, the user can select/modify the countertop 517. FIG. 6E thus shows the same user interface 500 as shown in FIG. 6D, but with a different countertop 518. Such a feature advantageously allows a user to view how different elements may look in a property without having to physically present the materials (or sample of the materials). Moreover, such a feature advantageously allows a party to passively market items to a user including, but not limited to, brands of televisions, appliances, lighting, and/or fixtures, among other aspects.

It should be appreciated that virtual laptop 515 may be activated when the user navigates near the laptop 515 in the virtual space. For example, once the user is “standing” near the laptop 515 in the virtual space, a “trigger” may be activated declaring the current position and allowing the laptop 515 to become active. A user may be able to “cycle” through different options using laptop 515 and once the user approves an option, the user can “touch” the screen of laptop 515 for selection thereby initiating the change. In one example, every time the screen of laptop 515 is “touched,” an available option will cycle thus allowing the user to experience many different options as quickly and effortlessly as possible. It should be further appreciated that different laptops 515 are available in each room and each laptop 515 may have several different or same options. Moreover, as a user approaches a specific laptop 515, a specific state can be defined (e.g., “Kitchen,” “Master Bedroom”) thus allowing the global state controller to know where the user is in the virtual environment and which laptop 515 to activate (as well as the array of options at each station associated with the laptop 515).

It should be appreciated that as options are selected, laptop 515 may display a price increase for each option. For example, laptop 515 may show how much the overall price will increase and/or the adjusted overall price increase of the property. In the examples shown in FIGS. 6D and 6E, the countertop 517 is changed to countertop 518 thus causing an additional cost (e.g., $325) in which the user can quickly determine if the change is a viable solution when building/modifying a property.

FIG. 6F thus shows a non-limiting example user interface 500 showing a total cost screen 519. In one non-limiting example, once the user has finished selecting the desired options (e.g., colors, objects, materials), the user can have an option of viewing the final build/modification price (as shown, for example, in total cost screen 519 of FIG. 6F). The user interface 500 shown in FIG. 6F may be located in front of an exterior property and can maintain a constant total cost variable (or can be shown through user input). The variable may be updated in real-time (e.g., through different interactions with laptops 515) and summing up all pricing options from all laptops 515.

In one non-limiting example, total cost screen 519 may show the starting point price for a property and, as changes are made, the price can be modified up/down. The total cost screen 519 may be viewed at any time while the user is in the virtual environment (e.g., by pressing an input button to change view showing the total cost screen 519). The system 1 can determine which laptops 515 are required to calculate the total cost and display screen 519. In one non-limiting example, once a laptop 515 is used and an option is selected, the price of the option may become available and the system can query all activated laptops 515. In one non-limiting example, system 1 may query all activated laptops 515 using at least two methods. In a first method, if only one laptop 515 is activated, there is no need to gather further data and thus the modified price can be added/subtracted to the total cost of the property. In a second method, if multiple laptops 515 are activated, the system 1 can gather all variables into a sum and add the sum to the total cost. The example shown in FIG. 6F shows a total cost of $349,300 as the total cost variable displayed in screen 519. These examples are of course non-limiting and the technology described herein envisions any manner for displaying cost and/or modifications to the virtual environment.

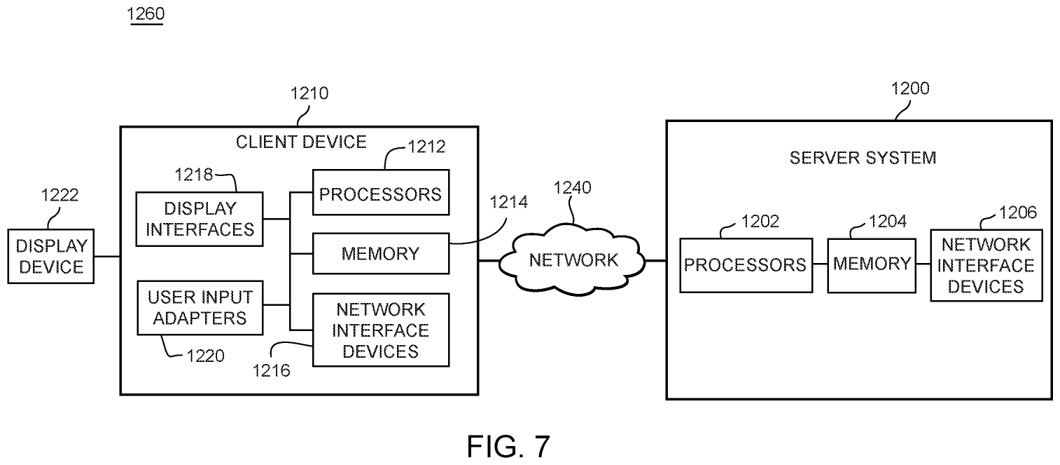

### Description of FIG. 7

FIG. 7 shows a non-limiting example block diagram of a hardware architecture for the system 1260. In the example shown in FIG. 7, the client device 1210 communicates with a server system 1200 via a network 1240. The network 1240 could comprise a network of interconnected computing devices, such as the internet. The network 1240 could also comprise a local area network (LAN) or could comprise a peer-to-peer connection between the client device 1210 and the server system 1200. As will be described below, the hardware elements shown in FIG. 7 could be used to implement the various software components and actions shown and described above as being included in and/or executed at the client device 1210 and server system 1200.

In some embodiments, the client device 1210 (which may also be referred to as “client system” herein) includes one or more of the following: one or more processors 1212; one or more memory devices 1214; one or more network interface devices 1216; one or more display interfaces 1218; and one or more user input adapters 1220. Additionally, in some embodiments, the client device 1210 is connected to or includes a display device 1222. As will explained below, these elements (e.g., the processors 1212, memory devices 1214, network interface devices 1216, display interfaces 1218, user input adapters 1220, display device 1222) are hardware devices (for example, electronic circuits or combinations of circuits) that are configured to perform various different functions for the computing device 1210.

In some embodiments, each or any of the processors 1212 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1212 uses an instruction set architecture such as x86 or Advanced RISC Machine (ARM).

In some embodiments, each or any of the memory devices 1214 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1212). Memory devices 1214 are examples of non-volatile computer-readable storage media.

In some embodiments, each or any of the network interface devices 1216 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces 1218 is or includes one or more circuits that receive data from the processors 1212, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 1222, which displays the image data. Alternatively or additionally, in some embodiments, each or any of the display interfaces 1218 is or includes, for example, a video card, video adapter, or graphics processing unit (GPU).

In some embodiments, each or any of the user input adapters 1220 is or includes one or more circuits that receive and process user input data from one or more user input devices (not shown in FIG. 7) that are included in, attached to, or otherwise in communication with the client device 1210, and that output data based on the received input data to the processors 1212. Alternatively or additionally, in some embodiments each or any of the user input adapters 1220 is or includes, for example, a PS/2 interface, a USB interface, a touchscreen controller, or the like; and/or the user input adapters 1220 facilitates input from user input devices (not shown in FIG. 7) such as, for example, a keyboard, mouse, trackpad, touchscreen, etc. . . .

In some embodiments, the display device 1222 may be a Liquid Crystal Display (LCD) display, Light Emitting Diode (LED) display, or other type of display device. In embodiments where the display device 1222 is a component of the client device 1210 (e.g., the computing device and the display device are included in a unified housing), the display device 1222 may be a touchscreen display or non-touchscreen display. In embodiments where the display device 1222 is connected to the client device 1210 (e.g., is external to the client device 1210 and communicates with the client device 1210 via a wire and/or via wireless communication technology), the display device 1222 is, for example, an external monitor, projector, television, display screen, etc. . . .

In various embodiments, the client device 1210 includes one, or two, or three, four, or more of each or any of the above-mentioned elements (e.g., the processors 1212, memory devices 1214, network interface devices 1216, display interfaces 1218, and user input adapters 1220). Alternatively or additionally, in some embodiments, the client device 1210 includes one or more of: a processing system that includes the processors 1212; a memory or storage system that includes the memory devices 1214; and a network interface system that includes the network interface devices 1216.

The client device 1210 may be arranged, in various embodiments, in many different ways. As just one example, the client device 1210 may be arranged such that the processors 1212 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the client device 1210 may be arranged such that: the processors 1212 include two, three, four, five, or more multi-core processors; the network interface devices 1216 include a first network interface device that implements Ethernet and a second network interface device that implements WiFi and/or Bluetooth; and the memory devices 1214 include a RAM and a flash memory or hard disk.

Server system 1200 also comprises various hardware components used to implement the software elements for server system 220 of FIG. 2 an. In some embodiments, the server system 1200 (which may also be referred to as “server device” herein) includes one or more of the following: one or more processors 1202; one or more memory devices 1204; and one or more network interface devices 1206. As will explained below, these elements (e.g., the processors 1202, memory devices 1204, network interface devices 1206) are hardware devices (for example, electronic circuits or combinations of circuits) that are configured to perform various different functions for the server system 1200.

In some embodiments, each or any of the processors 1202 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1202 uses an instruction set architecture such as x86 or Advanced RISC Machine (ARM).

In some embodiments, each or any of the memory devices 1204 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1202). Memory devices 1204 are examples of non-volatile computer-readable storage media.

In some embodiments, each or any of the network interface devices 1206 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In various embodiments, the server system 1200 includes one, or two, or three, four, or more of each or any of the above-mentioned elements (e.g., the processors 1202, memory devices 1204, network interface devices 1206). Alternatively or additionally, in some embodiments, the server system 1200 includes one or more of: a processing system that includes the processors 1202; a memory or storage system that includes the memory devices 1204; and a network interface system that includes the network interface devices 1206.

The server system 1200 may be arranged, in various embodiments, in many different ways. As just one example, the server system 1200 may be arranged such that the processors 1202 include: a multi (or single)-core processor; a first network interface device (which implements, for example, WiFi, Bluetooth, NFC, etc. . . . ); a second network interface device that implements one or more cellular communication technologies (e.g., 3G, 4G LTE, CDMA, etc. . . . ); memory or storage devices (e.g., RAM, flash memory, or a hard disk). The processor, the first network interface device, the second network interface device, and the memory devices may be integrated as part of the same SOC (e.g., one integrated circuit chip). As another example, the server system 1200 may be arranged such that: the processors 1202 include two, three, four, five, or more multi-core processors; the network interface devices 1206 include a first network interface device that implements Ethernet and a second network interface device that implements WiFi and/or Bluetooth; and the memory devices 1204 include a RAM and a flash memory or hard disk.

As previously noted, whenever it is described in this document that a software module or software process performs any action, the action is in actuality performed by underlying hardware elements according to the instructions that comprise the software module. Consistent with the foregoing, in various embodiments, each or any combination of the client device 210 or the server system 220, each of which will be referred to individually for clarity as a “component” for the remainder of this paragraph, are implemented using an example of the client device 1210 or the server system 1200 of FIG. 7. In such embodiments, the following applies for each component: (a) the elements of the client device 1210 shown in FIG. 7 (i.e., the one or more processors 1212, one or more memory devices 1214, one or more network interface devices 1216, one or more display interfaces 1218, and one or more user input adapters 1220) and the elements of the server system 1200 (i.e., the one or more processors 1202, one or more memory devices 1204, one or more network interface devices 1206), or appropriate combinations or subsets of the foregoing, are configured to, adapted to, and/or programmed to implement each or any combination of the actions, activities, or features described herein as performed by the component and/or by any software modules described herein as included within the component; (b) alternatively or additionally, to the extent it is described herein that one or more software modules exist within the component, in some embodiments, such software modules (as well as any data described herein as handled and/or used by the software modules) are stored in the respective memory devices (e.g., in various embodiments, in a volatile memory device such as a RAM or an instruction register and/or in a non-volatile memory device such as a flash memory or hard disk) and all actions described herein as performed by the software modules are performed by the respective processors in conjunction with, as appropriate, the other elements in and/or connected to the client device 1210 or server system 1200; (c) alternatively or additionally, to the extent it is described herein that the component processes and/or otherwise handles data, in some embodiments, such data is stored in the respective memory devices (e.g., in some embodiments, in a volatile memory device such as a RAM and/or in a non-volatile memory device such as a flash memory or hard disk) and/or is processed/handled by the respective processors in conjunction, as appropriate, the other elements in and/or connected to the client device 1210 or server system 1200; (d) alternatively or additionally, in some embodiments, the respective memory devices store instructions that, when executed by the respective processors, cause the processors to perform, in conjunction with, as appropriate, the other elements in and/or connected to the client device 1210 or server system 1200, each or any combination of actions described herein as performed by the component and/or by any software modules described herein as included within the component.

The hardware configurations shown in FIG. 7 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the hardware configuration described above with reference to FIG. 7, (e) via other hardware arrangements, architectures, and configurations, and/or via combinations of the technology described in (a) through (e).

### Technical Advantages of Described Subject Matter

The technology described herein allows for improved human-computer interaction with the system. The technology advantageously provides the user with a simulated environment that gives the user a more immersive and realistic experience for interacting with the environment. Moreover, the technology describes an improved user interface that allows the user to customize the environment as well as customize how the environment is viewed (e.g., by changing viewing modes).

### Selected Definitions

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### Further Applications of Described Subject Matter

Although a number of references are made in this document to web applications, it should be understood that the features described herein may also be used, in various embodiments, in the context of other types of applications such as applications that are deployed/installed as binaries on client systems.

Although process steps, algorithms or the like, including without limitation with reference to FIGS. 1-7, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or

[symbol]

1. A system configured to generate and manipulate a virtual building in a virtual three-dimensional space, comprising:
a client system having processing circuitry that includes at least a memory, a processor, and a communications device; and
a server system having processing circuitry that includes at least a memory, a processor, and a communications device, the processing circuitry of the server system configured to:
obtain architectural plans for a building;
generate data associated with a virtual building in a virtual three-dimensional space using the obtained architectural plans; and
transmit the data associated with the virtual building in the virtual three-dimensional space to the client system using at least the communications device,
the processing circuitry of the client system configured to:
receive the data transmitted from the server system;
render the virtual three-dimensional space, including the virtual building, navigable by a user using a virtual reality device using the received data; and
dynamically modify one or more portions of the virtual building in the virtual three-dimensional space based on user input, wherein
a view of the virtual building in the virtual three-dimensional space is modifiable based on the user input, and
a cost associated with the virtual building in the virtual three-dimensional space is displayable in association with the virtual building.

2. The system of claim 1, wherein the architectural plans for the building are obtained from a data file containing information associated with a floor plan of the building.

3. The system of claim 1, wherein generating the virtual building using the obtained architectural plans includes:
designing a floor plan, including exterior and interior elements, using the architectural plans;
adding specific elements of the floor plan for the exterior and interior elements;
opening a real-time three-dimensional development platform; and
obtaining a three-dimensional model into a new scene.

4. The system of claim 3, wherein generating the virtual building further includes:
adding external elements to the three-dimensional model; and
building a file associated with the three-dimensional model configured for pushing to the virtual reality device.

5. The system of claim 1, wherein dynamically modifying the one or more portions of the virtual building includes:
enabling opening and/or closing of doors and/or windows;
enabling operation of lights and/or plumbing; and
modifying physical structure of the virtual building.

6. The system of claim 1, wherein the environment is displayable in a first view showing interior and exterior structure including walls inside the building.

7. The system of claim 6, wherein the environment is configured to display a second view showing interior plumbing of the interior structure behind the walls.

8. The system of claim 7, wherein the environment is configured to display a third view showing interior electrical configurations of the interior structure behind the walls.

9. The system of claim 1, wherein the cost dynamically changes based on modifications to the virtual building.

10. The system of claim 1, wherein one or more items inside the virtual building are passively marketed from one or more different companies.

11. A method for generating and manipulating a virtual building in a virtual three-dimensional space, comprising:
obtaining architectural plans for a building;
generating data associated with a virtual building in a virtual three-dimensional space using the obtained architectural plans; and
transmitting the data associated with the virtual building in the virtual three-dimensional space to a client system, wherein
one or more portions of the virtual building are dynamically modifiable in the virtual three-dimensional space based on user input, and
a view of the virtual building in the virtual three-dimensional space is modifiable based on the user input.

12. The method of claim 11, wherein a cost associated with the virtual building in the virtual three-dimensional space is displayable in association with the virtual building.

13. The method of claim 11, wherein the environment is displayable in a first view showing interior and exterior structure including walls inside the building.

14. The method of claim 13, wherein the environment is configured to display a second view showing interior plumbing of the interior structure behind the walls.

15. The method of claim 14, wherein the environment is configured to display a third view showing interior electrical configurations of the interior structure behind the walls.

16. A client system, comprising:
a processor; and
a memory configured to store computer readable instructions that, when executed by the processor, cause the system to:
receive data transmitted from a server system;
render a virtual three-dimensional space, including a virtual building, navigable by a user using the received data; and
dynamically modify one or more portions of the virtual building in the virtual three-dimensional space based on user input.

17. The system of claim 16, wherein a view of the virtual building in the virtual three-dimensional space is modifiable based on the user input.

18. The system of claim 17, wherein the environment is displayable in a first view showing interior and exterior structure including walls inside the building.

19. The system of claim 18, wherein the environment is configured to display a second view showing interior plumbing of the interior structure behind the walls.

20. The system of claim 19, wherein the environment is configured to display a third view showing interior electrical configurations of the interior structure behind the walls.
